(19) United States
(12) Patent Application Publication
(10) Pub. No.: US 2017/0175356 A1
(43) Pub. Date: Jun. 22, 2017

(54) LOCKING COVER FOR CONSTRUCTION VAULT

(71) Applicant: Diversatech, Inc., Pennington, NJ (US)

(72) Inventors: Haskel Zeloof, Stockton, NJ (US); Thomas Vanderpool, Quakertown, PA (US)

(21) Appl. No.: 15/452,144

(22) Filed: Mar. 7, 2017

Related U.S. Application Data
(63) Continuation-in-part of application No. 14/640,142, filed on Mar. 6, 2015.

(51) Int. Cl. E02D 29/14; E05B 65/00; E05C 3/04; E05B 35/00

(52) U.S. Cl. CPC E02D 29/1427; E05B 35/008; E05B 65/006; E05C 3/041; E02D 2300/0029; E02D 2300/0035; E02D 2300/0025; E02D 2300/002

(57) ABSTRACT

A locking cover apparatus for construction vaults. The cover has a latch portion configured to rotate in a first and second direction when a threaded locking security bolt is rotated in the first and second direction respectively, and where the cover is locked from removal from the vault when the latch portion comes into contact with a first stop mechanism after rotating in the first direction and wherein the cover is unlocked when the latch portion comes into contact with a second stop mechanism after rotating in the second direction.

### CROSS-REFERENCE TO RELATED APPLICATIONS

This application is a continuation-in-part of U.S. application Ser. No. 14/640,142 filed on Mar. 6, 2015, which is herein incorporated by reference in its entirety.

### BACKGROUND OF THE INVENTIVE FIELD

The present invention is directed to locking covers for vault openings. More particularly, the present invention is directed to a novel cover for existing subgrade vault openings.

Traditional vaults for holding or storing construction equipment and materials (e.g., voltage wires for street lamps) do not have locking mechanisms and are easily broken into. These vaults are subject to burglars who steal the expensive construction materials and devices costing municipalities and states millions of dollars per year. The present invention meets the need for securing these existing subgrade vaults against theft without the need for reconstructing the vault itself.

### SUMMARY OF THE GENERAL INVENTIVE CONCEPT

In one embodiment of the present invention, the invention is comprised of a cover having a through hole, the cover having an outside surface and an inside surface, wherein the cover is positioned in a substantially vertical or vertical position when installed over the opening of a vault; a threaded locking security bolt for placement in the through hole; a latch portion with a threaded opening for operationally engaging the threaded locking security bolt; a latch stop, wherein the latch stop is adapted to attach to the inside surface of the cover; wherein the latch portion is configured to rotate in a first and second direction when the threaded locking security bolt is rotated in the first and second direction respectively, and wherein the cover is locked from removal from the vault when the latch portion comes into contact with the latch stop after rotating in the first direction and wherein the cover is unlocked when the latch portion comes into contact with the latch stop after rotating in the second direction.

The foregoing and other features and advantages of the present invention will be apparent from the following more detailed description of the particular embodiments, as illustrated in the accompanying drawings.

### BRIEF DESCRIPTION OF THE DRAWINGS

The following detailed description of the example embodiments refers to the accompanying figures that form a part thereof. The detailed description provides explanations by way of exemplary embodiments. It is to be understood that other embodiments may be used having mechanical and electrical changes that incorporate the scope of the present invention without departing from the spirit of the invention.

In addition to the features mentioned above, other aspects of the present invention will be readily apparent from the following descriptions of the drawings and exemplary embodiments, wherein like reference numerals across the several views refer to identical or equivalent features, and wherein:

FIG. 1A illustrates one embodiment of a top view of the locking cover of the present invention;

FIG. 1B illustrates one embodiment of a side view of the locking cover of the present invention;

FIG. 2 illustrates one embodiment of a bottom view of the locking cover of the present invention;

FIG. 3 illustrates one embodiment of a lifting ring of the present invention;

FIG. 4 illustrates one embodiment of a bolt cover of the present invention;

FIG. 5 illustrates one embodiment of a key tool of the present invention;

FIG. 6 illustrates one embodiment of a key tool and locking bolt of the present invention;

FIG. 7 illustrates one embodiment of an instruction decal;

FIG. 8A illustrates one embodiment of a corner locking flange weldment of the present invention having a stop pin and a vertical mounting bracket;

FIG. 8B illustrates an alternate embodiment of a corner locking flange weldment of the present invention having a hole for screwing on the cover;

FIG. 8C illustrates an alternate embodiment of a corner locking flange weldment of the present invention having a stop pin and a horizontal mounting bracket;

FIG. 9 illustrates one embodiment of a locking flag of the present invention;

FIG. 10 illustrates one embodiment of a vault assembly of the present invention showing installed corner locking flange weldments;

FIG. 11 illustrates an alternative embodiment of a locking latch cover of the present invention;

FIG. 12 illustrates one embodiment of the key pattern on the head of a threaded locking security bolt of the present invention;

FIG. 13 illustrates a side view of one embodiment of the locking latch cover of the present invention;

FIG. 14 illustrates a side view of a key tool engaged to the locking latch cover of the present invention in an unlocked position;

FIG. 15 illustrates one embodiment of a side view of a key tool engaged to the locking latch cover of the present invention as the latch portion is turned in a first direction;

FIG. 16 illustrates a side view of a key tool engaged to the locking latch cover of the present invention in a locked position (if the cover was on the vault);

FIG. 17 illustrates a side view of the latch portion clamped to the inside surface of the cover;

FIG. 18 illustrates one embodiment of the inside surface of the cover showing the latch portion;

FIG. 19 illustrates one embodiment of the locking latch cover of the present invention installed on a vault in an unlocked position;

FIG. 20 illustrates one embodiment of the locking latch cover of the present invention installed on a vault in a locked position;

FIG. 21 illustrates one embodiment of a support bracket of the present invention;

FIG. 22 illustrates one embodiment of a recessed lip of a vault opening;

FIG. 23 illustrates a back view of one embodiment of the locking latch apparatus installed on a vault;

FIG. 24A illustrates another front/outside view of the locking latch cover of the present invention;

FIG. 24B illustrates another side view of the locking latch cover of the present invention;

FIG. 25 illustrates another locking latch cover of the present invention.

### DETAILED DESCRIPTION OF EXEMPLARY EMBODIMENT(S)

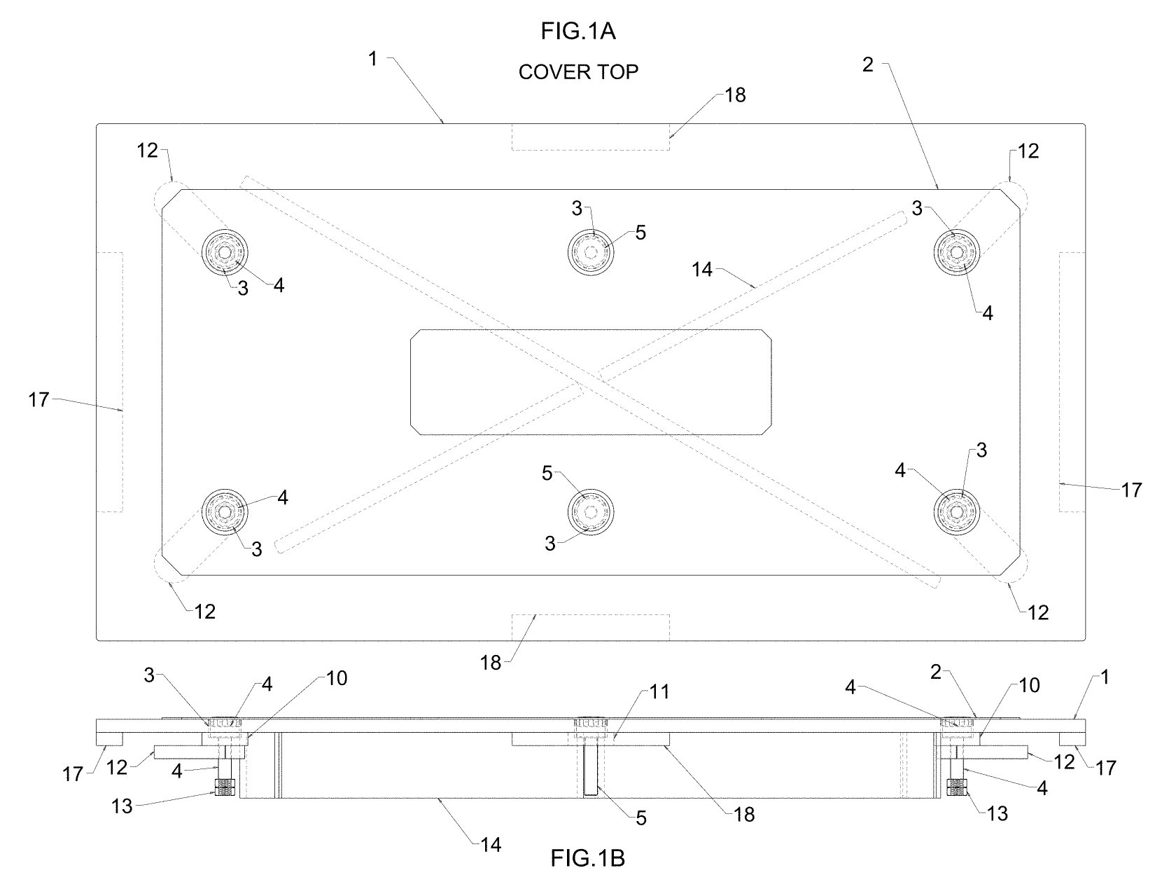

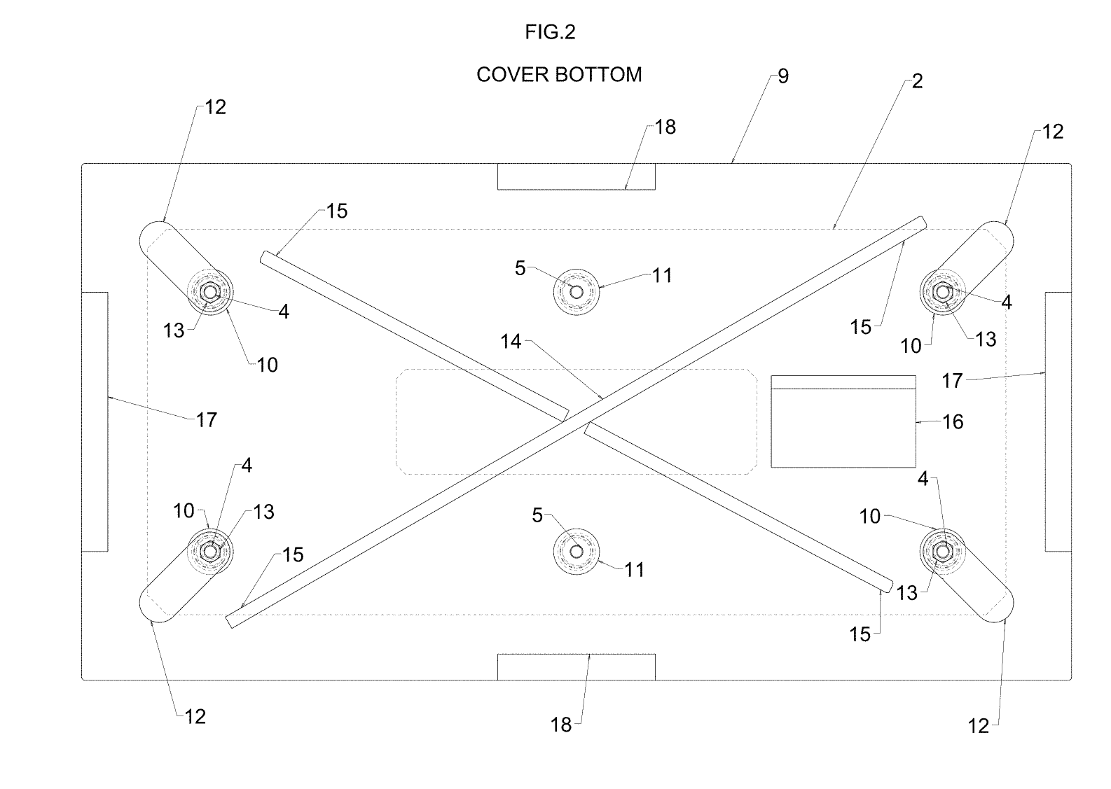

FIG. 1A illustrates one embodiment of a top view of the locking cover 1 of the present invention. FIG. 1B illustrates one embodiment of a side view of the locking cover of the present invention. FIG. 2 illustrates one embodiment of a bottom 9 view of the locking cover of the present invention.

A tread plate 2 is preferably constructed from a non-skid, ADA approved surface. For example, the cover can be made from stainless steel, aluminum, cold rolled steel or various other materials. The cover can also be made with various types, patterns, thicknesses and materials. For example, the cover can be constructed of a shatterproof material. In one embodiment, the entire cover and all hardware is made of non-corroding materials that cannot be cut into or compromised by an oxyacetylene torch. The cover can also be configured to meet HS20 loading requirements.

Through holes in the cover 3 provide clearance to permit the diameter of the locking bolt head to pass through, and become recessed below, the cover surface. The locking security bolts 4 are preferably high-security locking bolts (e.g., supplied by McGard Co.).

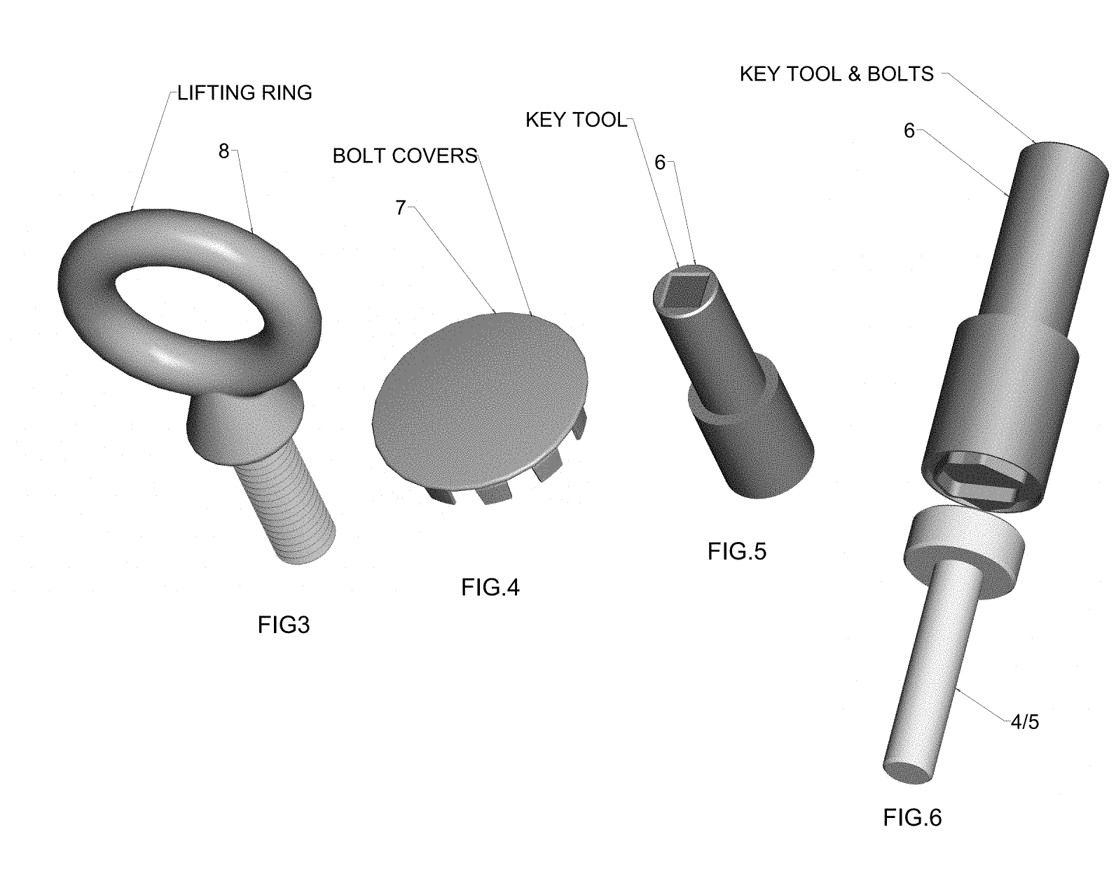

FIG. 3 illustrates one embodiment of a lifting ring of the present invention. FIG. 4 illustrates one embodiment of a bolt cover of the present invention. FIG. 5 illustrates one embodiment of a key tool of the present invention. FIG. 6 illustrates one embodiment of a key tool and locking bolt of the present invention. In the preferred embodiment, the locking pattern on the bolts is unique and matched to a corresponding key tool 6. The pattern is registered to the manufacture of the bolt and is not repeated or provided to other customers. The key tool is engaged to the top of the bolt and the outer sleeve is threaded onto the bolt head outside diameter so as to hold the key tool in place during use. In one embodiment, the cover of the present invention provides 4-point security as each corner is secured in place.

Locking lifting bolts 5 are similar to the locking security bolts described above, but are used to conceal two threaded locations which, when the bolts are removed, expose threads which are used for insertion of eyehook lifting rings 8 for use in removal and installation of the cover. When these two bolts are installed, the appearance of two additional locking locations and an illusion of greater security is provided.

Bolt covers 7 are preferably placed on top of the bolts to keep dirt, debris, water, etc. away from the locking security bolts and to prevent corrosion. Unlike existing covers, the cover of the present invention is preferably impenetrable to wildlife and insects such as bees, wasps, snakes, mice, rats, etc., providing a safer environment for workers as well as protecting the conduit and components inside from damage.

There are four counterbored spacers 10, each having a through hole to allow the locking bolts to pass through. The counterbore allows for part of the locking bolt head to be recessed below the ½″ cover plate so that none of the locking bolt heads extend above the top surface of the cover.

Lifting bolt spacers 11, similar to the counterbored spacers, are preferably used and the center holes are threaded to accommodate two of the locking security bolts, or lifting rings, as needed. The cover preferably provides an impervious and smooth installation, with no holes or access as in existing units. The locking mechanism is preferably fully recessed and inaccessible by any conventional tool.

Locking flags (or latches) 12 are mechanically and operationally connected to the locking security bolts so that when the threaded locking security bolts are rotated clockwise, the locking flags rotate and hit the stop pin 25 on the corner locking flange weldment and then move up and towards and clamp against the top flange 20. The flag portion (or latch portion) of the locking flag locks the cover in place when placed under the top flange portion of the corner locking flange weldment. In the preferred embodiment, the locking flag has an internal threaded portion that is matched to the locking security bolts. As the locking security bolts are turned, the locking flags rotate. Once the locking flag hits the stop pin, further rotational movement of the locking flag is prevented, however, as the locking security bolt is turned, the locking flag will continue to move upward on the bolt. This latching mechanism does not require adjustment or setting as it automatically stops when tight, unlike other systems. Double jam nuts 13 are used in one embodiment, which are tightened against one another and prevent the locking flags from unthreading and disengaging from the locking security bolt.

A stiffener X brace 14 is attached to the cover in one embodiment. The brace is preferably a welded brace that provides additional strength and load-carrying capacity to the cover. It also acts as a stop for the locking flags during counterclockwise rotation of the locking security bolts allowing the flags to stop rotating and move away from the top flange as the bolt is turned. The brace also protects all of the cover components during removal, handling and shipping, since the components do not extend past the height of the brace.

In one embodiment of the invention (FIG. 2), self-adhesive flag decals 15 are attached depicting proper positioning for each individual locking flag prior to installation of the cover. If each flag is not in the proper position, the stop pins could be engaged on the incorrect side and the locking flags will not correctly mate with the top flange.

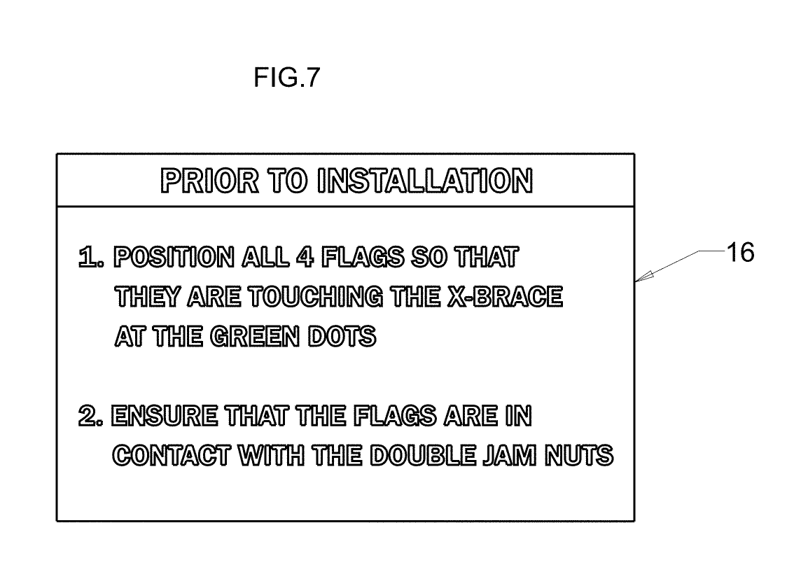

In one embodiment (FIG. 2), the decals 15 are a 1″ green dot which acts as an indicator for the flag positioning. Both decals locate the locking flag in the proper orientation for installation. The verbiage on the decal 16 instructs the user to, prior to installation: 1) position all four flags so that they are touching the X-brace at the green dots; and 2) ensure that the flags are in contact with the double jam nuts. FIG. 7 illustrates one embodiment of the instruction decal.

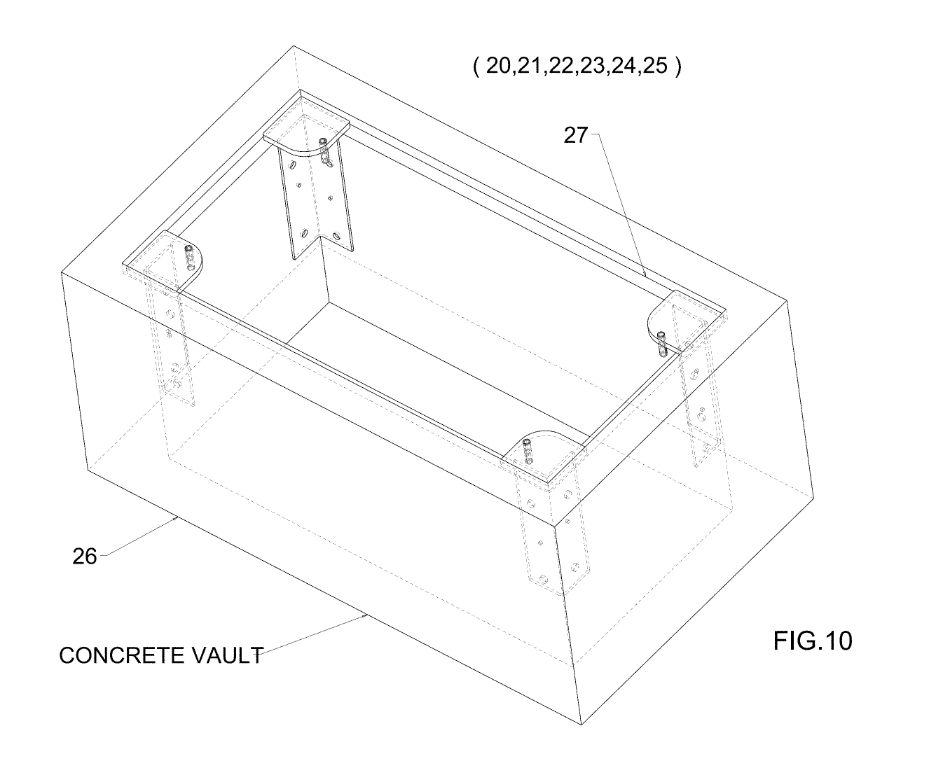

In one embodiment of the invention, end support bars 17 are placed on the bottom of the cover. In this embodiment, because the cover rests upon ½″ thick top flanges, these ½″ thick spacer end bars provide additional support and load-carrying capacity. (The ½″ cover is spaced an additional ½″ up to fill the 1″ deep space of the existing vault opening (27).) (The lip of the vault (shown at 27) is 1″ from the opening of the vault in the embodiment shown (e.g., FIG. 10)).

Side support bars 18 can also be used in addition to the end support bars. Additionally, the end and side support bars provide additional structural support should one or more of the corner locking flange weldments be eliminated due to potential interference with a conduit or other obstruction.

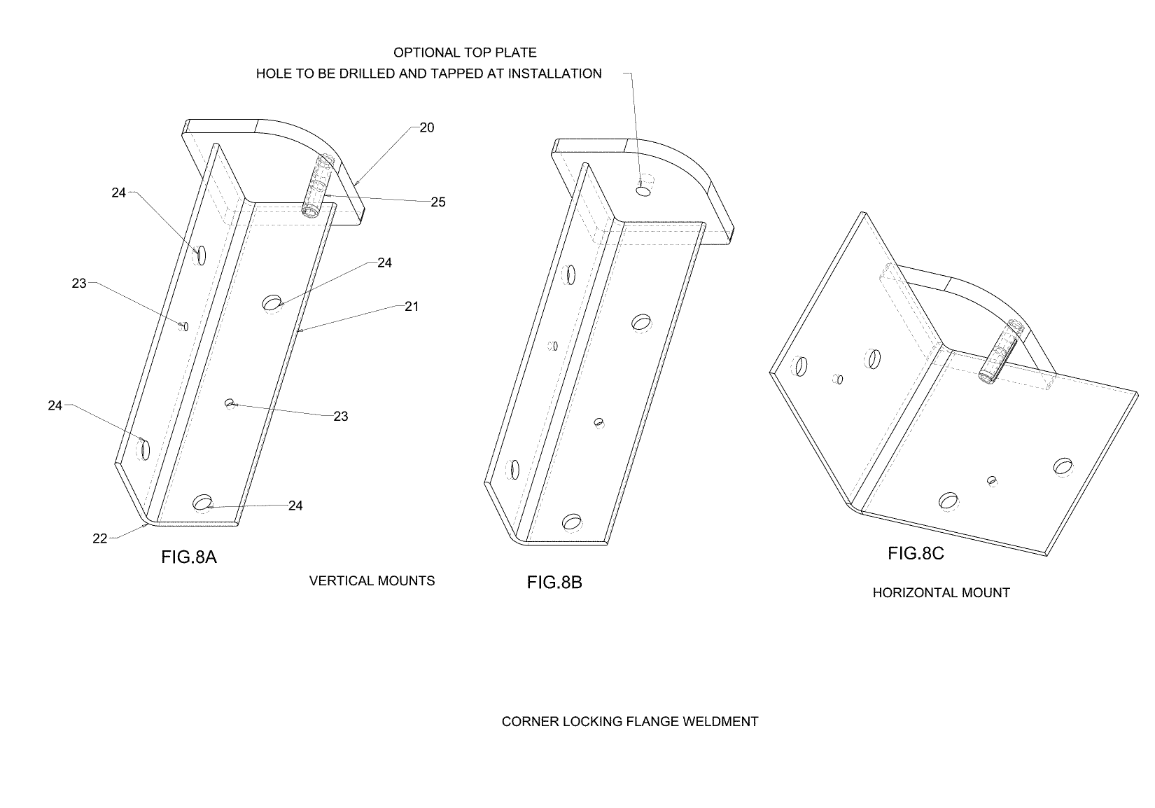

FIG. 8A illustrates one embodiment of a corner locking flange component (e.g., weldment) of the present invention having a stop pin and a vertical mount component. FIG. 8B illustrates an alternate embodiment of a corner locking flange weldment of the present invention having a threaded hole for screwing on the cover. With the embodiment of FIG. 8B, traditional hardware is used in lieu of the corner locking flange components and locking flags. In this embodiment, the cover is bolted onto the corner locking flange weldment. FIG. 8C illustrates an alternate embodiment of a corner locking flange weldment of the present invention having a horizontal mount component. The mount components are preferably angle mounting brackets 21 with holes for accepting fasteners.

A top flange 20 is secured, by welding or another method, to the top of the mounting bracket for use in securing the locking latch components and locking the cover as previously described. In other words, once the locking flag is in the locked position under the top flange, the cover cannot be removed from above as the locking flag is secured in place by the top flange. The top flange overhangs the angle mounting bracket (by ⅞″ in one embodiment) and allows for positioning of the entire corner locking flange weldment onto the vault opening. In the preferred embodiment, no measuring or positioning of the corner locking flange weldment is necessary; it is self-fixturing.

Since no lip or flange exists in many existing, smooth-walled, concrete vaults, this provision allows the locking flags to rotate into position and pull tight against the top flange to secure the cover. The top flange also acts as a spacer (in one embodiment, the flange is ½″ thick allowing the ½″ lid to sit flush with the top of the existing vault opening). It is appreciated that different size top flanges may be used with various size vaults and/or covers.

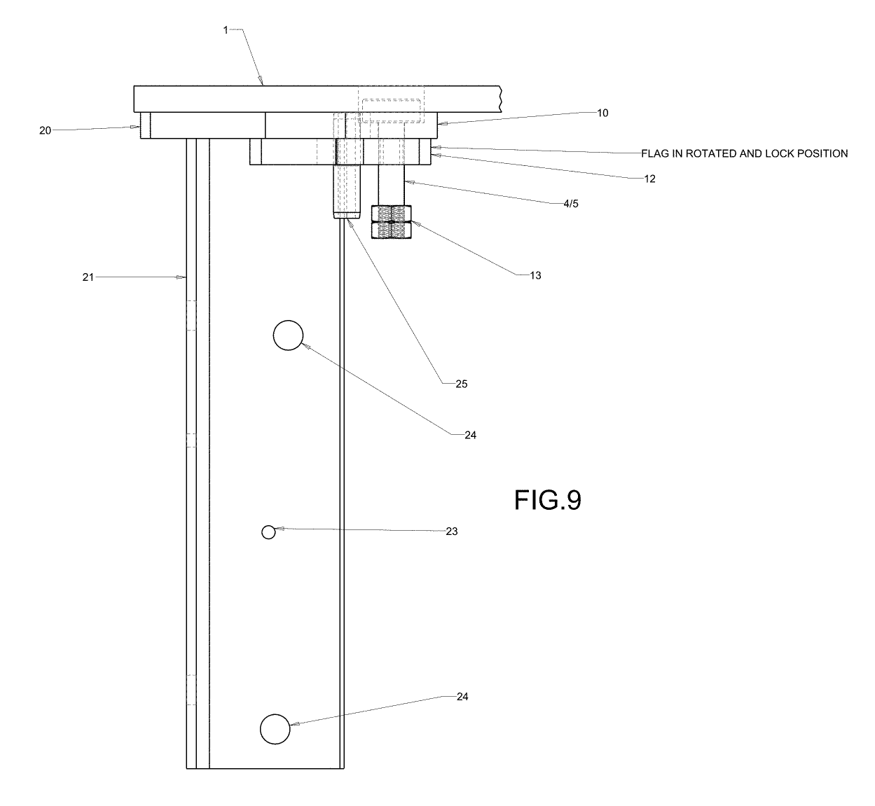

The stop pin 25 acts as a stop for the locking flag. When the locking security bolts are rotated clockwise, the locking flag rotates until it comes in contact with the stop pin and cannot rotate further. Its motion then becomes linear and it rises until it comes into firm contact with the top flange securing the cover. FIG. 9 illustrates one embodiment of a locking flag of the present invention in a locked position against the top flange.

The angle mounting bracket is a component of the corner locking flange weldment that allows the component to be securely mounted to existing vault walls. In one embodiment, the angle mounting bracket has a radiused corner 22 to allow for installation against any potential existing debris in the vault opening which could impede installation. The bracket can also be shimmed to fit any wall that is not straight or that is tapered. The design allows for uneven and/or non-plumb conditions and structures which are out of square. The cover can be installed securely with as few as two of the corner locking flange weldments installed diagonally if conditions so require.

In one embodiment of the invention, the corner locking flange weldment is comprised of multiple ¼″ positioning holes 23 for insertion of fasteners into the vault wall (e.g., Hilti-type fasteners) to hold the corner locking flange component for final installation (acts like a second set of hands during installation).

In one embodiment, the corner locking flange weldment is comprised of multiple 9/16″ mounting holes 24 for securing anchors into the vault wall and for securing the corner locking flange weldment in place. The holes also act as a drill template for the main anchors. There is no measuring required.

FIG. 10 illustrates one embodiment of a vault 26 assembly of the present invention. In this embodiment, the vault is an existing concrete vault, although the cover of the present invention can be used with various types of vaults of various sizes and shapes. In this embodiment, the vault has a one inch lip (shown at 27), although the cover of the present invention can be used with vaults without lips.

In an alternative embodiment, the cover of the present invention can be unlocked from the inside, ensuring that no human can be inadvertently locked inside. For example, the cover can be configured so that the lock flags can be easily turned and unlocked from the inside of the vault. For example, in one embodiment of the invention, a safety wrench can be attached to a location on the bottom of the cover which can be used by a person to turn the locking flags to an unlocked position.

As discussed, the present invention allows for the retrofit of existing concrete construction vaults already installed in the field with the secure cover of the present invention. In other words, with the present invention, an installer can install the four corner brackets into an existing concrete vault by screwing the corner brackets directly into the walls of the concrete vault. With the present invention, because the flange mounting brackets are secured directly to the walls of the vault (e.g., existing concrete vault), they can be installed below the vault opening so that the top of the flange portion is recessed lower than the top of the vault (see, e.g., FIG. 10). In this fashion, once the cover is placed on the flange mounting brackets, the top of the vault cover is flush with the top of the vault (see, e.g., FIG. 10; see also above stating that the flange is ½″ thick and the cover is ½″ thick so that the cover fits flush inside the 1″ lip of the vault). This provides tremendous practical advantages if the existing concrete vault is place under a road surface for example, where the cover must not protrude above the surface of the road. This also makes it harder to break into.

In an alternative embodiment of the invention, a locking latch apparatus is comprised of a cover with a through hole for accepting a threaded locking security bolt for placement in the through hole. A latch portion is configured to rotate in a first and second direction when the threaded locking security bolt is rotated in the first and second direction respectively, and where the cover is locked from removal from the vault when the latch portion comes into contact with the latch stop after rotating in the first direction and wherein the cover is unlocked when the latch portion comes into contact with the latch stop after rotating in the second direction.

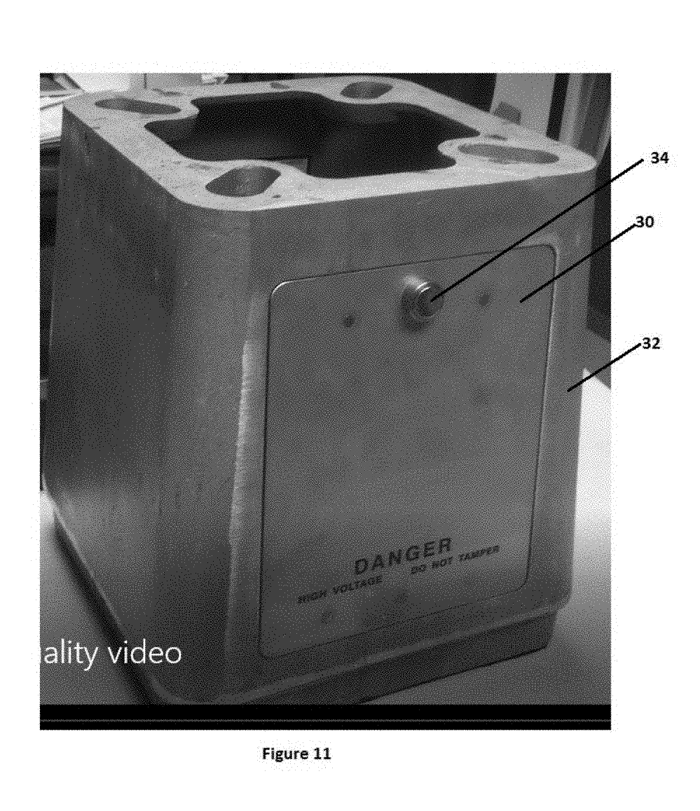

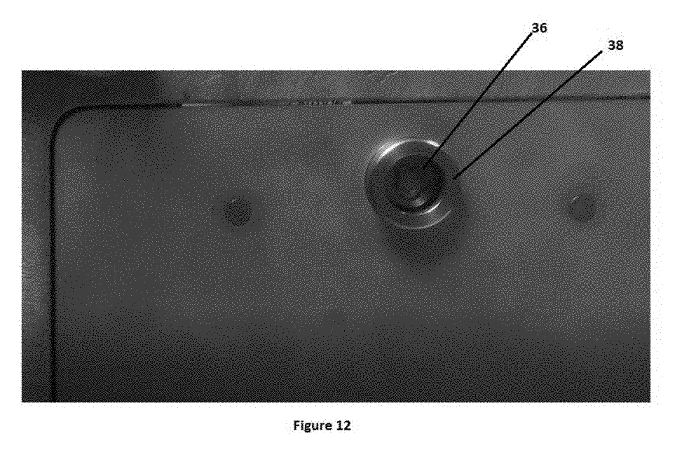

FIG. 11 illustrates the alternative embodiment of a locking latch cover of the present invention. The locking latch cover 30 is shown installed on a vault 32 (e.g., light pole base as shown in FIG. 11). In this embodiment, the vault is shown as a construction vault where the opening is in one of the sidewalls of the vault. In this embodiment, the locking cover is installed and positioned in a substantially vertical position. A clip-on button 34 hides the key pattern on the head of a threaded locking security bolt. This button can be removed to access the key pattern. FIG. 12 illustrates one embodiment of the key pattern 36 on the head of a threaded locking security bolt of the present invention. A collar 38 is attached to the outside surface of the cover and positioned to surround the through hole. This collar provides protection against vandals and thieves as the collar makes it harder to pry open or break into the vault.

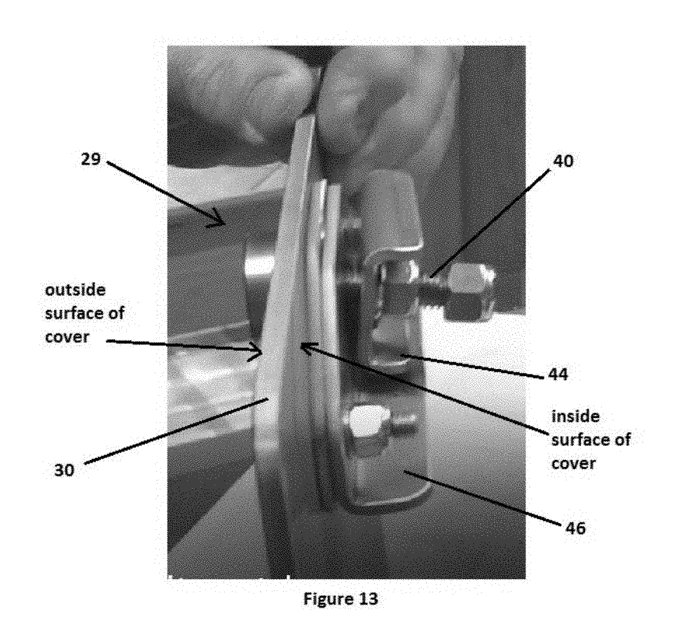

FIG. 13 illustrates a side view of one embodiment of the locking latch cover 29 of the present invention. The cover 30, threaded locking security bolt 40, latch portion 44, and locking bracket or latch stop 46 is illustrated. In one embodiment, the latch stop is bolted to the inside surface of the cover. In another embodiment, the latch stop is welded to the inside cover. In one embodiment, the threaded opening in the latch portion is provided by a nut welded onto the latch portion and wherein the nut has an opening that aligns with the through hole. In this embodiment, the threaded locking security bolt is positioned through the through hole in the cover and into the threaded opening in the latch portion. The threaded security bolt is in operational engagement with the latch portion so that rotation of the bolt causes rotation of the latch portion. In FIG. 13, the latch portion is shown in the unlocked portion and the cover is shown removed from the vault. The outside and inside surface of the cover is also shown. The latch portion resides in the inside of the vault when the cover is installed onto and over the vault opening.

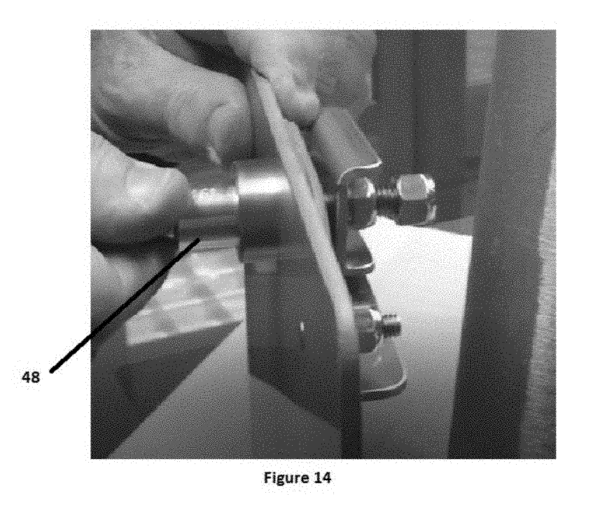

FIG. 14 illustrates a side view of a key tool 48 engaged to the locking latch cover of the present invention in an unlocked position. The key tool has a circular shape that fits inside the collar portion and the key tool has a key pattern that matches the pattern on the head of the threaded locking security bolt. The key tool is used to rotate the threaded locking security bolt from the unlocked position (as shown in FIG. 14) to the locked position. In this embodiment, the key tool is rotated in the clockwise direction to lock the latch portion when the cover is installed on the vault.

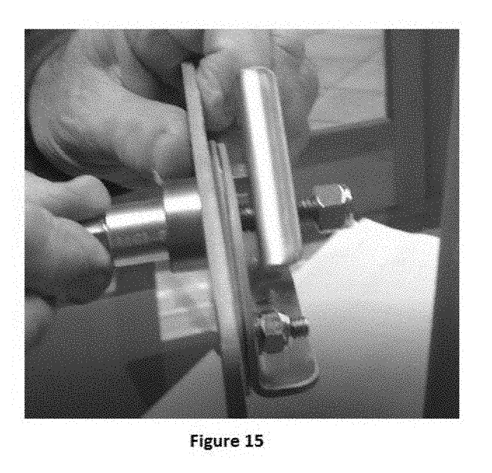

FIG. 15 illustrates one embodiment of a side view of a key tool engaged to the locking latch cover of the present invention as the latch portion is turned in a first direction (or clockwise). As illustrated in the figure, as the user turns the key tool clockwise, the threaded locking security bolt (that goes through the through hole in the cover) also turns. As the threaded locking security bolt turns clockwise, the latch portion goes from the unlocked position (in this embodiment, horizontal position), towards the locked position (or in this embodiment, vertical position).

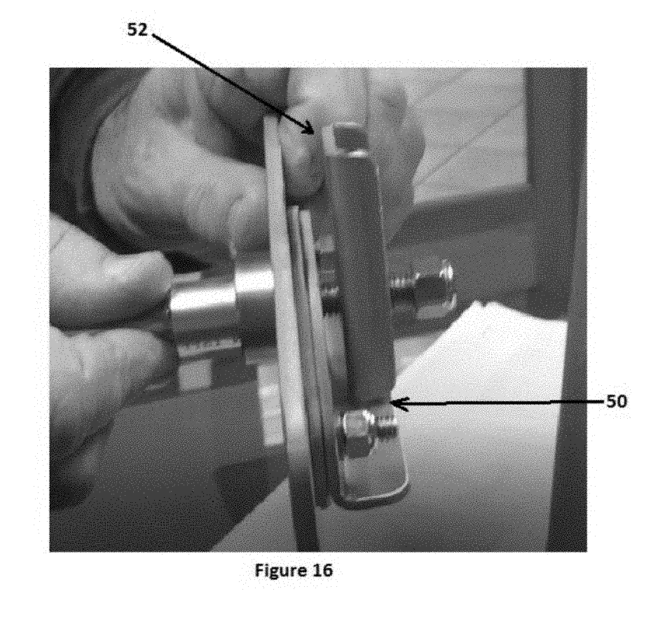

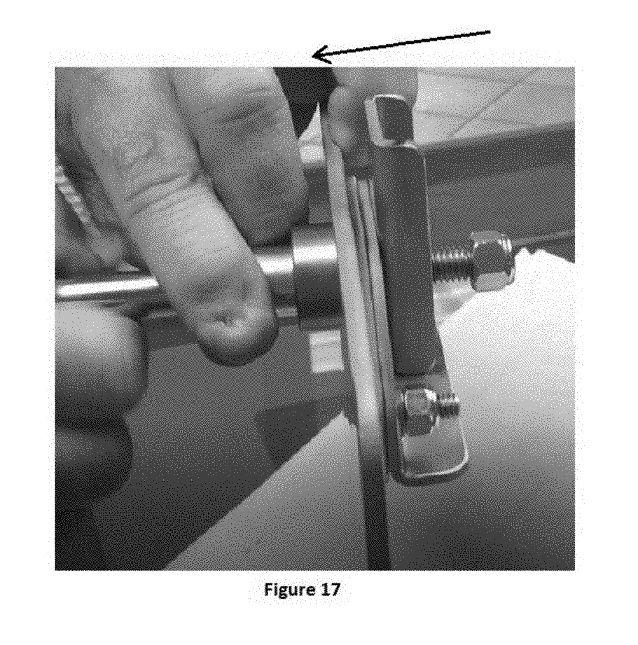

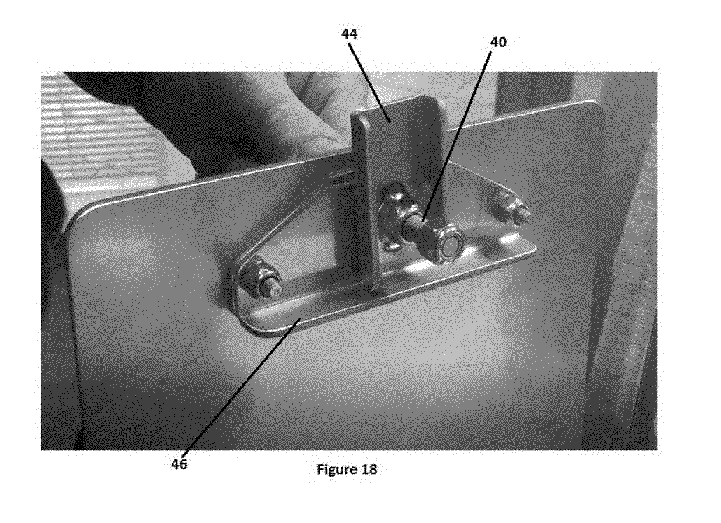

FIG. 16 illustrates a side view of a key tool engaged to the locking latch cover of the present invention in a locked position (if the cover was on the vault). As illustrated, in this position, the latch portion has come in contact with the latch stop (shown generally at point 50) after the user has turned the threaded locking security bolt in the clockwise direction. At this position, the latch stop will prevent the latch portion from rotating further in the clockwise direction. As illustrated, at this point, the latch portion is now in the vertical position. If the cover was installed on the vault, the latch portion in this position would prevent the cover from being removed from the vault as the end of the latch portion (shown generally at 52) would hit the inside surface of the vault preventing removal of the cover.

FIG. 17 illustrates a side view of the latch portion clamped to the inside surface of the cover. As the user continues to turn the key tool clockwise, the threaded locking security bolt will continue to screw into the latch portion. Because the latch portion cannot rotate further in the clockwise direction (because it is in contact with the latch stop), the latch portion will move towards the inside surface of the cover (or inside surface of the vault when the cover is installed on the vault). See the arrow in FIG. 17, showing the direction the latch portion moves as the key tool is turned in the clockwise direction. After sufficient clockwise rotation of the key tool, the latch portion will rest against the top inside portion of the vault and will act as a clamp against the inside surface of the vault. This provides the advantage of providing a tight seal for the cover. For example, if a seal is provided by a gasket around the opening.

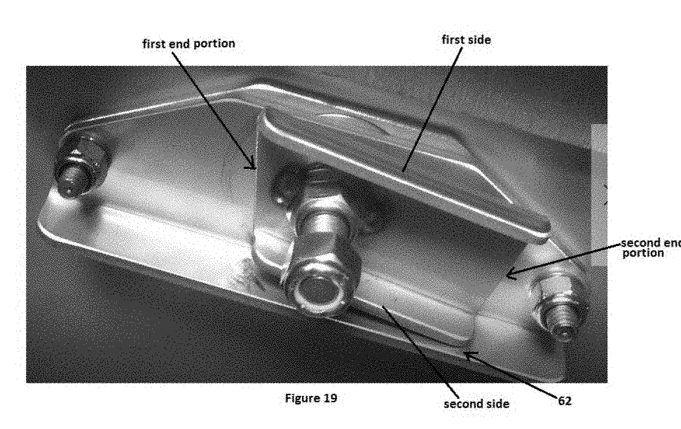

FIG. 18 illustrates one embodiment of the inside view of the cover (when viewed from inside a vault) showing the threaded locking security bolt 40, latch portion 44, and latch stop 46 is illustrated. Again, this illustrates the latch portion in the locked position. If the user turns the key tool, and the threaded security bolt to the counterclockwise position, the latch portion will also rotate to the unlocked position. FIG. 19 illustrates one embodiment of the locking latch cover of the present invention installed on a vault in an unlocked position. As illustrated, in this embodiment, the latch portion is comprised of a first side and a second side. The latch portion also has a first end portion and a second end portion. In this embodiment, the first end portion is angled. In other words, the first side is longer than the second side. Because the second side is shorter, the latch portion is allowed to rotate when the user turns the key tool in the clockwise direction. The first side is made longer so that it will contact the latch stop to stop further rotation when the latch portion is in the locked position.

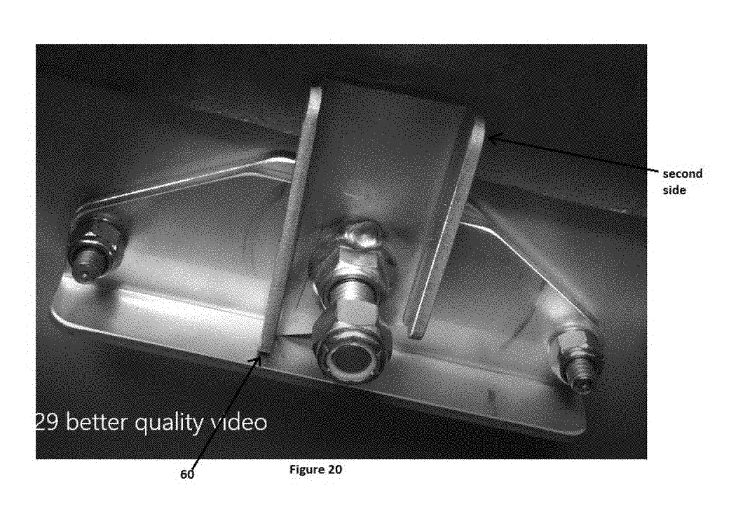

FIG. 20 illustrates one embodiment of the locking latch cover of the present invention installed on a vault in a locked position. Again, as the user turns the key tool in the clockwise direction, the latch portion will also rotate clockwise until a first end (shown generally at 60 in FIG. 20) of the first side comes into contact with the latch stop. To unlock the cover, the user can turn the key tool in the counter-clockwise direction until the second side of the latch portion comes into contact with the latch stop (the point that the second side hits the latch stop is shown generally at 62 in FIG. 19).

In an alternative embodiment, instead of using the long latch stop, a first stop mechanism (e.g., pin, block, stop) can be placed at location 60 to stop rotation of the latch portion in the locked position and a second stop mechanism can be placed at location 62 to stop rotation of the latch portion in the unlocked position.

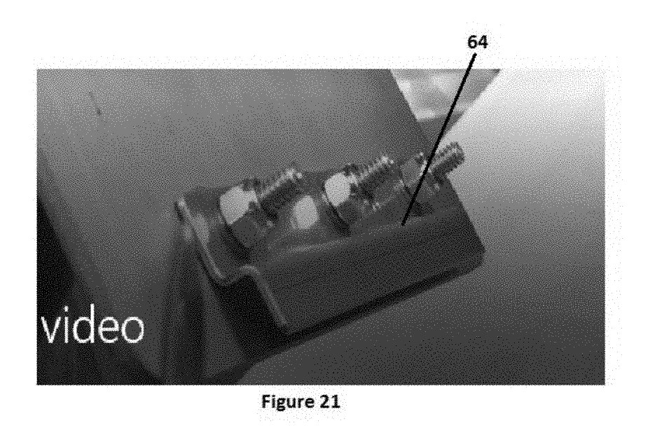

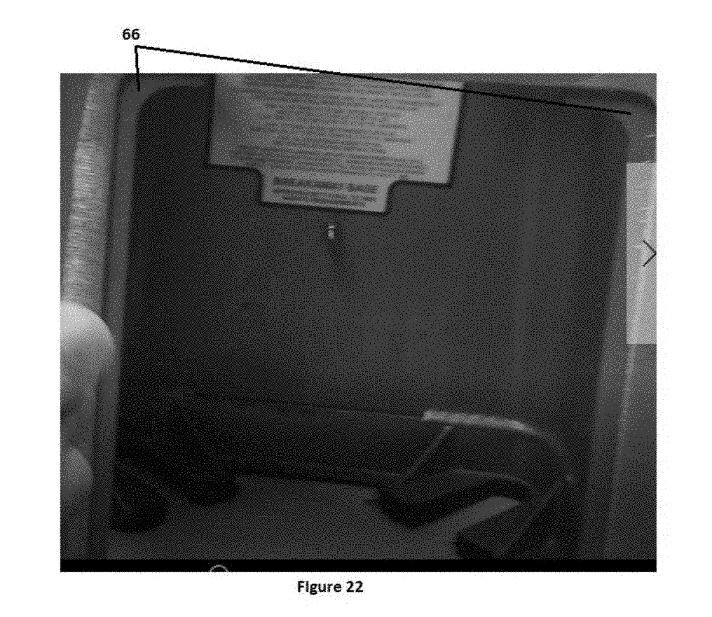

FIG. 21 illustrates one embodiment of a support bracket 64 of the present invention. The support bracket also presents the cover from being pulled off the recessed lip when the latch is in the locked position. FIG. 22 illustrates one embodiment of a recessed lip 66 of a vault opening. The cover is supported by the lip in the installed position. The support bracket is attached to the inside surface of the cover, and in this embodiment, is a Z-shaped bracket for resting on the recessed lip.

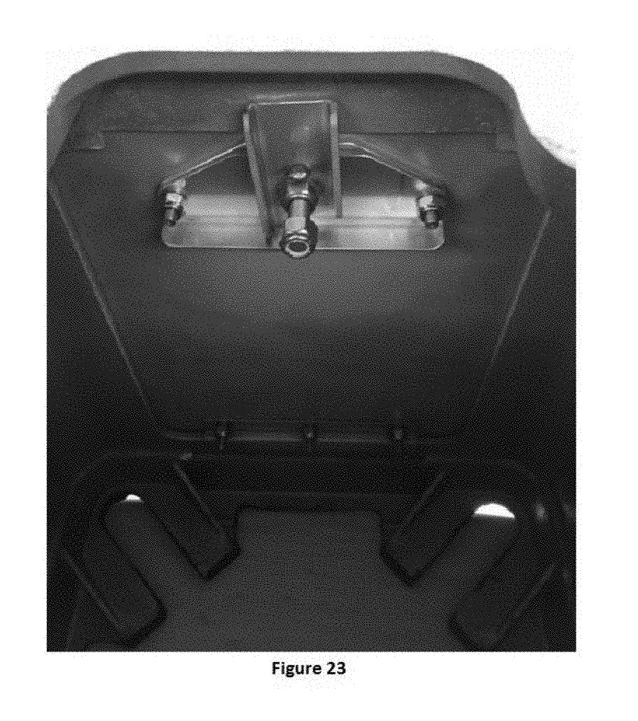

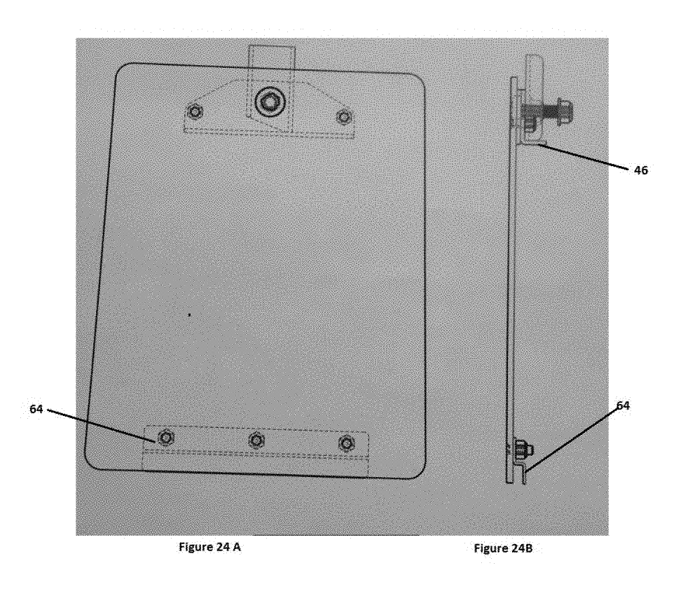

FIG. 23 illustrates a back/inside view of one embodiment of the locking latch apparatus installed on a vault. As illustrated, when the latch portion is in the locked position, one end of the latch portion is adjacent to the inside of the vault preventing removal of the cover. FIG. 24A illustrates another front/outside view of the locking latch cover of the present invention. FIG. 24B illustrates another side view of the locking latch cover of the present invention.

In one embodiment, the threaded locking security bolt is engaged to the threaded opening in a snug fashion so that the latch portion rotates when the threaded locking security bolt is rotated. For example, the threaded opening is fitted with a nylon component or insert for providing friction against the threaded locking security bolt. In another embodiment, the treaded locking security bolt is coated with a friction-providing material for providing friction against the threaded opening. This snug connection is important where the cover is positioned in a substantially vertical position on the vault. If the connection between the threaded opening of the latch portion and the bolt is not snug, gravity will cause the latch portion to fall towards the earth preventing rotation of the latch portion as needed to lock and unlock the cover.

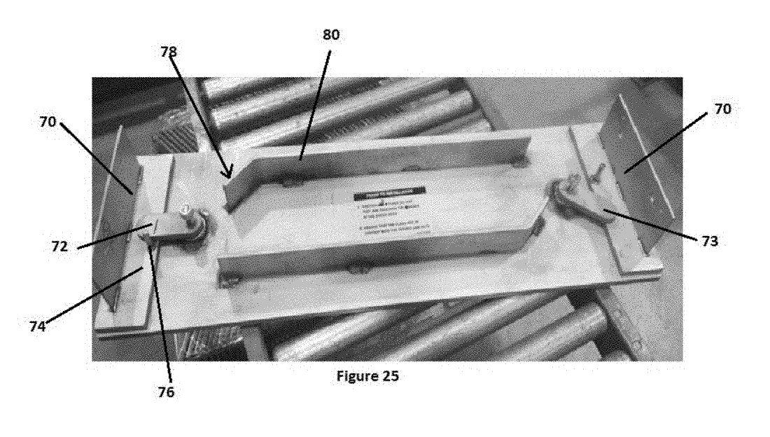

FIG. 25 illustrates another locking latch cover of the present invention. In this embodiment, brackets 70 are preferably mounted to the inside of a vault (similar to the corner brackets of the first embodiment of the invention described above (FIGS. 1-10) except the brackets are not mounted in the corners of the vault). In one embodiment, the brackets of FIG. 25 can be mounted to the sides of a vault (where the vault is in the ground or in a wall). The cover can be disposed in the vertical or horizontal position depending on where the opening is in the vault. FIG. 25 illustrates an inside view of the locking latch cover. The latch portion 72 is shown in the locked position against the flange portion 74 of the bracket. Upon rotation of the threaded security bolt, the latch portion rotates until it hits the stop pin 76 and is positioned in the locked position. The user can then turn the threaded security bolt in the opposite direction until it hits the stiffener component 80 (at the point shown generally at 78) where it stops and is positioned in the unlocked position. The other latch portion 73 works in the same fashion.

While certain embodiments of the present invention are described in detail above, the scope of the invention is not to be considered limited by such disclosure, and modifications are possible without departing from the spirit of the invention as evidenced by the following claims:

What is claimed is:

1. A locking cover apparatus for a vault having side walls, and an opening in one of the side walls, the locking cover apparatus comprising:
a cover having a through hole, the cover having an outside surface and an inside surface, wherein the cover is positioned in a substantially vertical or vertical position when installed over the opening of the vault;
a threaded locking security bolt for placement in the through hole;
a latch portion with a threaded opening for operationally engaging the threaded locking security bolt;
a latch stop, wherein the latch stop is adapted to attach to the inside surface of the cover;
wherein the latch portion is configured to rotate in a first and second direction when the threaded locking security bolt is rotated in the first and second direction respectively, and wherein the cover is locked from removal from the vault when the latch portion comes into contact with the latch stop after rotating in the first direction and wherein the cover is unlocked when the latch portion comes into contact with the latch stop after rotating in the second direction.

2. The locking cover apparatus of claim 1, further comprising:
a collar attached to the outside surface of the cover and positioned to surround the through hole.

3. The locking cover apparatus of claim 1, wherein the threaded locking security bolt is engaged to the threaded opening in a snug fashion so that the latch portion rotates when the threaded locking security bolt is rotated.

4. The locking apparatus of claim 3, wherein the threaded opening is fitted with a nylon component or insert for providing friction against the threaded locking security bolt.

5. The locking apparatus of claim 3, wherein the treaded locking security bolt is coated with a friction-providing material for providing friction against the threaded opening.

6. The locking cover apparatus of claim 1, wherein the threaded opening is provided by a nut welded onto the latch portion and wherein the nut has an opening that aligns with the through hole.

7. The locking cover apparatus of claim 1, further comprising a lock portion attached to a first end of the threaded locking security bolt, and wherein the lock portion is configured with a pattern for accepting a key tool for rotating the threaded locking security bolt.

8. The locking cover apparatus of claim 1, wherein the latch stop is bolted to the inside surface of the cover.

9. The locking cover apparatus of claim 1, wherein the first direction is in the clockwise direction and wherein the second direction is in the counterclockwise direction.

10. The locking cover apparatus of claim 1, wherein the latch portion is configured to pull closer to the inside surface of the cover by the threads of the threaded locking security bolt when the threaded locking security bolt is rotated further in the first direction.

11. The locking cover apparatus of claim 10, wherein the latch portion eventually clamps against the inside surface of the cover after rotating the threaded locking security bolt in the first direction a certain number of rotations.

12. The locking cover apparatus of claim 1, wherein the latch portion has a first and second end portion and a first and second side, and wherein the first end portion is angled and wherein the first side has a first and second end, and wherein the first side is longer than the second side, and wherein the latch portion is in the locked position when the first end of the first side comes into contact with the latch stop after the latch portion is rotated in the first direction, and wherein the latch portion is in the unlocked position when the second side of the latch portion comes into contact with the latch stop after the latch portion is rotated in the second direction.

13. The locking cover apparatus of claim 1, wherein the opening of the vault has a recessed lip, and wherein the cover is supported by the lip.

14. The locking cover apparatus of claim 1, further comprising a support bracket attached to the cover for resting on the recessed lip.

15. A locking cover apparatus for a vault having side walls, and an opening, the locking cover apparatus comprising:
a cover having a through hole, the cover having an outside surface and an inside surface;
a threaded locking security bolt for placement in the through hole;
a latch portion with a threaded opening for operationally engaging the threaded locking security bolt;
a first stop mechanism protruding from the inside surface of the cover;
a second stop mechanism protruding from the inside surface of the cover;
wherein the latch portion is configured to rotate in a first and second direction when the threaded locking security bolt is rotated in the first and second direction respectively, and wherein the cover is locked from removal from the vault when the latch portion comes into contact with the first stop mechanism after rotating in the first direction and wherein the cover is unlocked when the latch portion comes into contact with the second stop mechanism after rotating in the second direction.

16. The locking cover apparatus of claim 15, further comprising:
a collar attached to the outside surface of the cover and positioned to surround the through hole.

17. The locking cover apparatus of claim 15, wherein the threaded locking security bolt is engaged to the threaded opening in a snug fashion so that the latch portion rotates when the threaded locking security bolt is rotated.

18. The locking apparatus of claim 17, wherein the threaded opening is fitted with a nylon component or insert for providing friction against the threaded locking security bolt.

19. The locking apparatus of claim 17, wherein the treaded locking security bolt is coated with a friction-providing material for providing friction against the threaded opening.

20. The locking cover apparatus of claim 15, wherein the threaded opening is provided by a nut welded onto the latch portion and wherein the nut has an opening that aligns with the through hole.

21. The locking cover apparatus of claim 15, further comprising a lock portion attached to a first end of the threaded locking security bolt, and wherein the lock portion is configured with a pattern for accepting a key tool for rotating the threaded locking security bolt.

22. The locking cover apparatus of claim 15, wherein the latch stop is bolted to the inside surface of the cover.

23. The locking cover apparatus of claim 15, wherein the first direction is in the clockwise direction and wherein the second direction is in the counterclockwise direction.

24. The locking cover apparatus of claim 15, wherein the latch portion is configured to pull closer to the inside surface of the cover by the threads of the threaded locking security bolt when the threaded locking security bolt is rotated further in the first direction.

25. The locking cover apparatus of claim 24, wherein the latch portion eventually clamps against the inside surface of the cover after rotating the threaded locking security bolt in the first direction a certain number of rotations.

26. The locking cover apparatus of claim 15, wherein the latch portion has a first and second end portion and a first and second side, and wherein the first end portion is angled and wherein the first side has a first and second end, and wherein the first side is longer than the second side, and wherein the latch portion is in the locked position when the first end of the first side comes into contact with the first stop mechanism after the latch portion is rotated in the first direction, and wherein the latch portion is in the unlocked position when the second side of the latch portion comes into contact with the second stop mechanism after the latch portion is rotated in the second direction.

27. The locking cover apparatus of claim 15, wherein the opening of the vault has a recessed lip, and wherein the cover is supported by the lip.

28. The locking cover apparatus of claim 15, further comprising a support bracket attached to the cover for resting on the recessed lip.

29. A locking cover apparatus for a vault having side walls, and an opening, the locking cover apparatus comprising:
a cover having a through hole, the cover having an outside surface and an inside surface;
a threaded locking security bolt for placement in the through hole;
a latch portion with a threaded opening for operationally engaging the threaded locking security bolt;
a first stop mechanism protruding from the inside surface of the cover;
a second stop mechanism protruding from the inside surface of the cover;
wherein the latch portion is configured to rotate in a first and second direction when the threaded locking security bolt is rotated in the first and second direction respectively, and wherein the cover is locked from removal from the vault when the latch portion comes into contact with the first stop mechanism after rotating in the first direction and wherein the cover is unlocked when the latch portion comes into contact with the second stop mechanism after rotating in the second direction; and
wherein the latch portion has a first and second end portion and a first and second side, and wherein the first end portion is angled and wherein the first side has a first and second end, and wherein the first side is longer than the second side, and wherein the latch portion is in the locked position when the first end of the first side comes into contact with the first stop mechanism after the latch portion is rotated in the first direction, and wherein the latch portion is in the unlocked position when the second side of the latch portion comes into contact with the second stop mechanism after the latch portion is rotated in the second direction.

30. The locking cover apparatus of claim 29, wherein the cover is positioned in a substantially vertical or vertical position when installed over the opening of the vault.

31. The locking cover apparatus of claim 15, wherein the cover is positioned in a substantially vertical or vertical position when installed over the opening of the vault.
